(19) United States
(12) Patent Application Publication
(10) Pub. No.: US 2025/0249608 A1
(43) Pub. Date: Aug. 7, 2025

(54) WIRE-BODY-MANAGING DEVICE, WIRE-BODY-MANAGING METHOD, AND ROBOT

(71) Applicant: FANUC CORPORATION, Yamanashi (JP)

(72) Inventor: Xing GENG, Yamanashi (JP)

(73) Assignee: FANUC CORPORATION, Yamanashi (JP)

(21) Appl. No.: 18/856,090

(22) PCT Filed: Jun. 6, 2022
(86) PCT No.: PCT/JP2022/022784

§ 371 Date: Oct. 11, 2024

(51) Int. Cl. B25J 19/00; H02G 11/00

(52) U.S. Cl. CPC B25J 19/0029; H02G 11/00

(57) ABSTRACT

A wire-body-managing device for routing a plurality of wire bodies between a first member and a second member that are supported so as to be relatively rotatable about a prescribed axis, and includes: an attachment unit for attaching to the second member; and a wire-body-securing part that secures the wire bodies passing, along the axis, through a hollow hole provided in a space including the axis of the first member and the second member, the wire bodies being bent on a side of the second member in directions intersecting the axis, the plurality of wire bodies are divided into a plurality of groups and are bent in different angular directions about the axis, and the wire-body-securing part secures the groups of wire bodies to different circumferential positions about the axis.

### TECHNICAL FIELD

The present disclosure relates to a wire-body-managing device, a wire-body-managing method, and a robot.

### BACKGROUND

There is a known robot including a base and an arm attached so as to be rotatable with respect to the base about a vertical first axis (for example, see Japanese Unexamined Patent Application, Publication No. 2018-140456). A cable group of this robot rises vertically upward in the base, then bends into a letter-U shape, extends vertically downward in the vicinity of the first axis, and enters the arm. The cable group that enters the arm has a form in which cables are lined up in a row in a radial direction, and is secured inside the arm by a securing member while keeping the lined-up form.

### SUMMARY

According to an aspect of the present disclosure, there is provided a wire-body-managing device for routing a plurality of wire bodies between a first member and a second member that are supported so as to be relatively rotatable about a prescribed axis, the device including: an attachment unit for attaching to the second member; and a wire-body-securing part that secures the wire bodies passing, along the axis, through a hollow hole provided in a space including the axis of the first member and the second member, the wire bodies being bent on a side of the second member in directions intersecting the axis, wherein the plurality of the wire bodies are divided into a plurality of groups and are bent in different angular directions about the axis, and the wire-body-securing part secures the groups of the wire bodies to different circumferential positions about the axis.

### BRIEF DESCRIPTION OF DRAWINGS

FIG. 1 is a partial vertical sectional view of a robot including a wire-body-managing device according to one embodiment of the present disclosure.

FIG. 2 is a perspective view of the wire-body-managing device illustrated in FIG. 1.

FIG. 3 is a diagram illustrating the positional relationship among one example of the mounting surfaces of a base to which the wire-body-managing device illustrated in FIG. 2 is mounted, a pulley, and a belt.

FIG. 4 is a plan view illustrating the routing direction of wire bodies extracted from a guide member in a top plate of the wire-body-managing device illustrated in FIG. 2.

FIG. 5 is a partial vertical sectional view of a robot including a first modification of the wire-body-managing device illustrated in FIG. 1.

FIG. 6 is a perspective view of another modification of the wire-body-managing device illustrated in FIG. 2.

### DETAILED DESCRIPTION OF EMBODIMENTS

A wire-body-managing device 10, a wire-body-managing method, and a robot 1 according to an embodiment of the present disclosure will now be described with reference to the drawings.

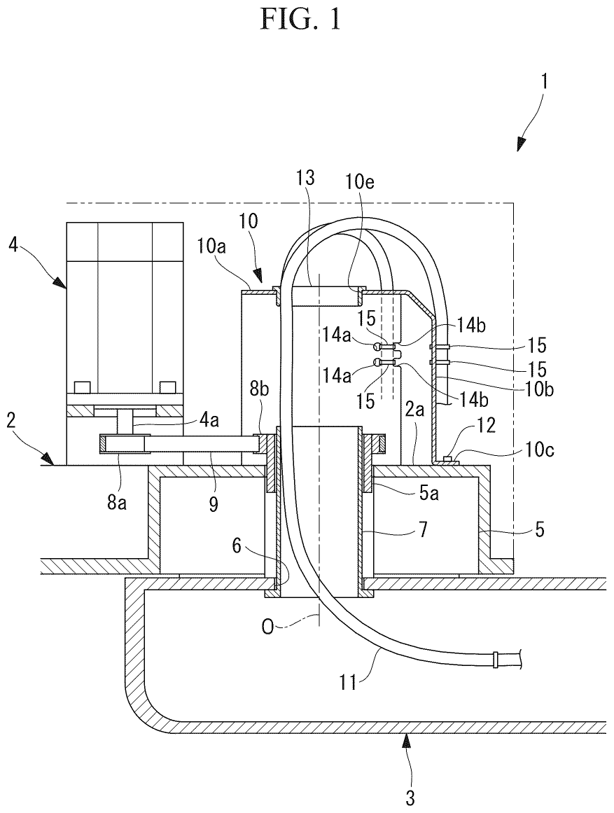

The robot 1 according to this embodiment is, for example, a horizontal articulated robot. As illustrated in FIG. 1, the robot 1 includes a base (second member) 2 to be installed onto an installation surface (not illustrated) such as a ceiling. The robot 1 also includes a first arm (first member) 3 that is supported so as to be rotatable about a vertical axis (prescribed axis) O with respect to the base 2.

The robot 1 includes a motor 4 that generates a torque on the side of the base 2. The robot 1 includes a reducer 5 that reduces the rotations of a shaft 4a of the motor 4 to drive the first arm 3 about the vertical axis O with respect to the base 2. The reducer 5 is sandwiched between the base 2 and the first arm 3 in the vertical direction.

The base 2, the first arm 3, and the reducer 5 have a hollow hole 6 that penetrates through the space including the vertical axis O in the vertical direction. The robot 1 includes a resin pipe 7 that extends through the hollow hole 6 from the side of the first arm 3 to the side of the base 2 and has a lower end secured to the first arm 3.

The reducer 5 includes a cylindrical input shaft 5a disposed at the outer radial side of the pipe 7 projecting toward the side of the base 2. The robot 1 includes pulleys (movable part) 8a and 8b respectively secured to the shaft 4a of the motor 4, and the input shaft 5a. The robot 1 also includes a belt (movable part) 9 looped over the pulleys 8a and 8b. Rotations of the shaft 4a of the motor 4 are transmitted to the input shaft 5a via the pulleys 8a and 8b and the belt 9 and are input to the reducer 5.

Furthermore, the robot 1 also includes a wire-body-managing device 10 according to one embodiment of the present disclosure.

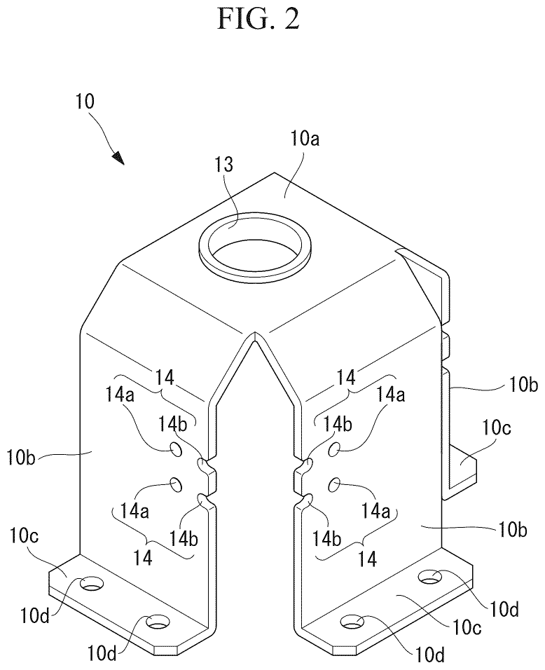

As illustrated in FIG. 2, the wire-body-managing device 10 according to this embodiment is mainly a bent sheet metal having a particular thickness. As illustrated in FIG. 1, the wire-body-managing device 10 has a rectangular top plate 10a that is horizontally positioned above the pipe 7 with a space vertically above the pipe 7.

In addition, as illustrated in FIG. 2, the wire-body-managing device 10 has three walls 10b that respectively connect to the three sides of the top plate 10a and that extend in a direction orthogonal to the top plate 10a. The corners where the top plate 10a and the walls 10b meet are formed at obtuse angles by, for example, bending a sheet metal twice at an angle of 45°. As a result, wire bodies 11 described below are prevented from becoming pressed against the corners of the boundaries between the top plate 10a and the walls 10b.

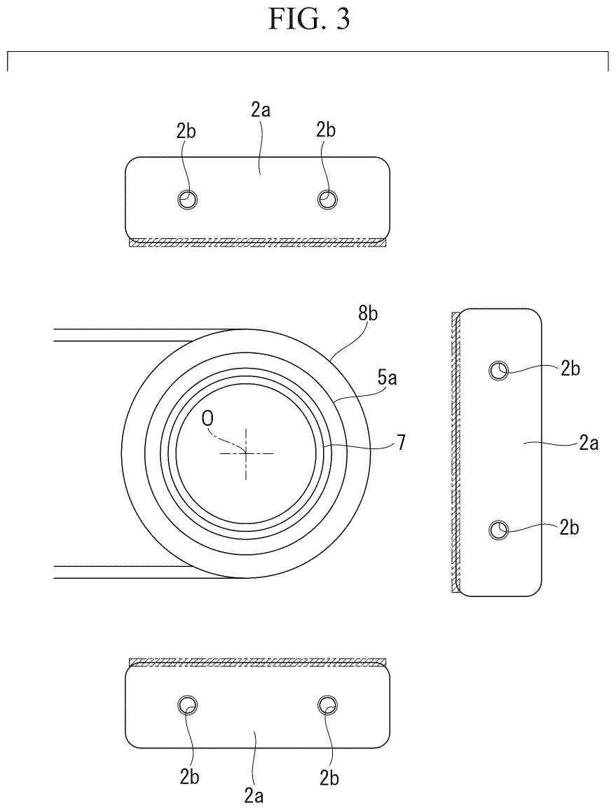

Each of the walls 10b has, at the tip thereof, a flange (attachment unit) 10c for securing the wire-body-managing device 10 to a mounting surface 2a of the base 2 with bolts 12. The flange 10c has through holes 10d that penetrate through in the plate thickness direction. The bolts 12 passing through the through holes 10d in the flange 10c are fastened with screw holes (see FIG. 3) 2b in the mounting surface 2a. As a result, the wire-body-managing device 10 can be secured to the base 2.

As illustrated in FIG. 3, the mounting surfaces 2a of the base 2 are located on the outer radial side of the pulley 8b secured to the input shaft 5a in a plan view. When the flanges 10c are fastened to the mounting surfaces 2a with the bolts 12, the walls 10b rise upward from the base 2 on the outer radial side of the pulley 8b. That is, the pulley 8b is disposed at such a position that the pulley 8b surrounds the outer radial side of the hollow hole 6, and the walls 10b are disposed at such positions that the walls 10b surround the outer radial side of the pulley 8b. As a result, the three walls 10b separate the space on the outer side of the walls 10b from the inner space where the pulley 8b and the belt 9 are disposed.

As illustrated in FIG. 1, the wire-body-managing device 10 has a round through hole 10e that penetrates through the top plate 10a in the plate thickness direction. The wire-body-managing device 10 also includes a cylindrical guide member 13 fitted to the through hole 10e. The guide member 13 is disposed at a position remote from the end portion of the hollow hole 6 in the vertical axis O direction. The guide member 13 is made of a resin, such as PTFE, that has excellent slidability. In a state where the wire-body-managing device 10 is secured to the base 2, the through hole 10e in the top plate 10a is located vertically above the pipe 7.

Each of the walls 10b has a plurality of through holes (wire-body-securing part) 14a that penetrate through in the plate thickness direction and notches (wire-body-securing part) 14b. The notches 14b may be replaced with through holes. The wire bodies 11 laid along the outer surface of the wall 10b in the vertical direction can be easily tied with tying bands 15 passed through the through holes 14a and the notches 14b. As a result, the wire bodies 11 that have passed through the pipe 7 can be secured on the side of the base 2.

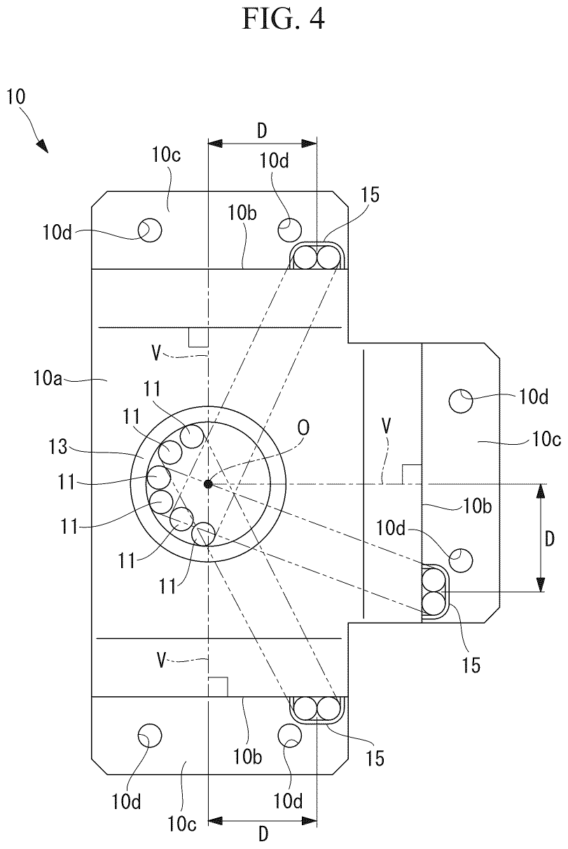

As illustrated in FIG. 2, the through holes 14a and the notches 14b (hereinafter referred to as wire-body-securing part 14) are provided in each of the three holes 10b. As illustrated in FIG. 4, each wire-body-securing part 14 secures the wire bodies 11 at a position a distance D away from a perpendicular line V extending from the vertical axis O to each wall 10b. Thus, in a state where the wire-body-managing device 10 is secured to the base 2, the wire-body-securing parts 14 are at different angular positions about the vertical axis O with respect to the hollow hole 6.

The robot 1 includes the plurality of wire bodies 11 that include air tubes and cables for a motor (not illustrated) mounted in the first arm 3, etc. . . . In the example illustrated in FIG. 4, there are six wire bodies 11. Each of the wire bodies 11 passes through the pipe 7 disposed in the hollow hole 6 in the vertical direction. In addition, the wire bodies 11 are secured on the side of the base 2 and on the side of the first arm 3 with respect to the pipe 7.

Next, a wire-body-managing method according to this embodiment is described with reference to the drawings.

The wire-body-managing method according to this embodiment divides the plurality of wire bodies 11 passing through the pipe 7 into a plurality of groups on the side of the base 2. In the example illustrated in FIG. 4, the number of groups is 3. As illustrated in FIG. 1, all groups of the wire bodies 11 are passed through the guide member 13 in the top plate 10a. Subsequently, the wire bodies 11 are bent into a letter-U shape and secured to different wire-body-securing parts 14 according to the group.

In other words, all of the wire bodies 11 rise in the vertical direction in the pipe 7 from the side of the first arm 3 to the side of the base 2, and pass through the guide member 13. Above the guide member 13, the groups of the wire bodies 11 are oriented in different angular directions in the circumferential direction with respect to the vertical axis O. Then the groups of the wire bodies 11 bend 180° and head vertically downward, and are secured to different wire-body-securing parts 14 of the walls 10b.

Under the pipe 7, the wire bodies 11 are bent in any desired directions intersecting the vertical axis O and are secured to the first arm 3 by any desired method.

When the first arm 3 is rotated about the vertical axis O with respect to the base 2, the position where the wire bodies 11 are secured in the first arm 3 undergoes displacement about the vertical axis O. The wire bodies 11 between the secured position in the first arm 3 and the wire-body-securing part 14 of the base 2 absorb the displacement by generating bends and twists. The wire bodies 11 are routed in the pipe 7, which penetrates through the hollow hole 6 including the vertical axis O, along the vertical axis O, and are bent on the both sides of the pipe 7. In this manner, the bending and twisting that occur in the wire bodies 11 due to the rotation of the first arm 3 with respect to the base 2 can be minimized.

According to this embodiment, the plurality of wire bodies 11 passed through the pipe 7 are divided into a plurality of groups and are bent in different angular directions about the vertical axis O. Since the wire bodies 11 are not bent in the same direction outside the pipe 7, there is no need to arrange all of the wire bodies 11 in one row when the wire bodies 11 pass through the pipe 7. As a result, the maximum external dimensions of the wire body 11 groups passing through the pipe 7 can be decreased. The inner diameter of the pipe 7 through which the wire body 11 groups pass, and the diameter of the hollow hole 6 of the reducer 5 etc., can be decreased, and thus the size of the robot 1 can be reduced.

Furthermore, the wire bodies 11 that have passed through the pipe 7 straight pass the guide member 13 thereabove, and emerge above the top plate 10a. Thus, the wire bodies 11 from the pipe 7 to the guide member 13 do not come into contact with the pulley 8b and belt 9 around the pipe 7. In addition, the portions of the wire bodies 11 emerging above the top plate 10a from the guide member 13 can also be isolated from the movable parts, such as the pulley 8b, by the top plate 10a and the walls 10b. As a result, the interference between the movable parts and the wire bodies 11 in the base 2 can be avoided even when the space inside the base 2 is small.

Furthermore, in this embodiment, a cylindrical guide member 13 is disposed by leaving a space above the upper end of the pipe 7. In this manner, the outer surfaces of the wire bodies 11 that bulge by being bent in the letter-U shape come into contact with the inner surface of the guide member 13, and thus the curvature can be reduced. Consequently, the bent portions of the wire bodies 11 are corrected to a compact shape, and the intense contact between the wire bodies 11 and the upper edge of the pipe 7 can be avoided. Moreover, the wire bodies 11 can be routed in a space-saving manner.

Furthermore, since the guide member 13 is provided separately from the pipe 7, the position of the guide member 13 can be adjusted to match the lengths of the wire bodies 11, and the curvature can be appropriately corrected. When a wide space can be spared inside the base 2 and the wire bodies 11 are allowed to have large-curvature bent portions, the guide member 13 may be omitted.

In this embodiment, the positions of the wire-body-securing parts 14 on the plate-shaped walls 10b are remote from the positions of the perpendicular lines V from the vertical axis O. In this manner, the radius of curvature of the letter-U shaped bends of the wire bodies 11 can be set larger than when the wire-body-securing parts 14 are arranged at the positions of the perpendicular lines V. As a result, while the wire-body-managing device 10 is compactly structured, the radius of curvature of the wire bodies 11 can be increased and the lifetime of the wire bodies 11 can be improved.

In this embodiment, an example in which the wire-body-managing device 10 is applied to a joint part that rotates the first arm 3 with respect to the base 2 is described. Alternatively, the device may be applied to any other joint, for example, a joint that rotates a second arm (not illustrated) with respect to the first arm 3.

Moreover, in this embodiment, an example of the wire-body-managing device 10 in which the wire bodies 11 passing through the pipe 7 are managed on the side of the base 2, and a method therefor is described. Alternatively, the same wire-body-managing device 10 and method may be employed to carry out the management on the side of the first arm 3. Alternatively, the same wire-body-managing device 10 and method may be used to management the wire bodies 11 on both sides of the pipe 7.

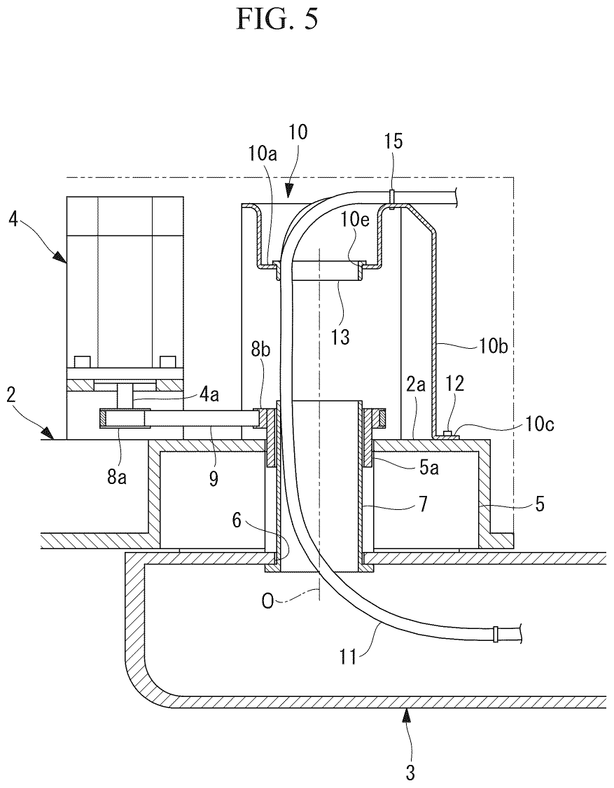

Moreover, in this embodiment, the wire bodies 11 passed through the pipe 7 are bent into a letter-U shape on the side of the base 2 and secured to the wire-body-securing parts 14. Alternatively, as illustrated in FIG. 5, the wire bodies 11 passed through the pipe 7 may be bent into a letter-L shape on the side of the base 2 and secured to the wire-body-securing parts 14. In such a case also, the groups of the wire bodies 11 may be bent in different angular directions in the circumferential direction about the vertical axis O.

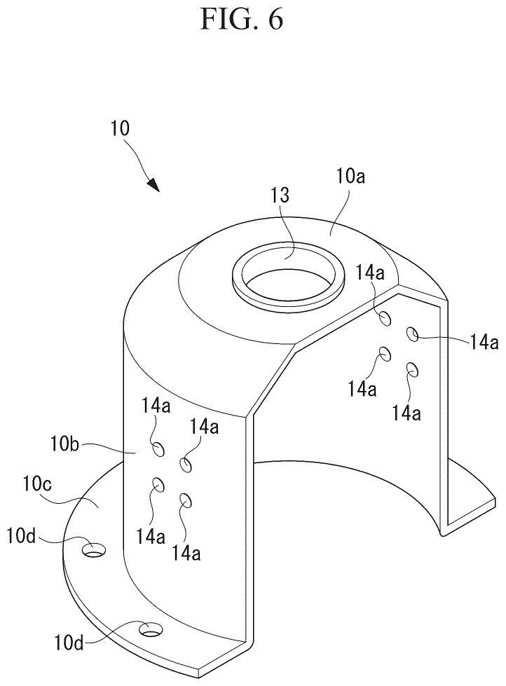

In this embodiment, the walls 10b having a plate shape are described as an example. Alternatively, as illustrated in FIG. 6, a cylindrical wall 10b may be employed.

Furthermore, in this embodiment, six wire bodies 11 are divided into three groups each with two wire bodies. Alternatively, any desired number of wire bodies 11 may be divided into any number of groups equal to or larger than 2. Furthermore, the number of wire bodies 11 in each group may be any as long as the number is 1 or more, and different groups may include different numbers of wire bodies 11.

In this embodiment, the resin pipe 7 is disposed in the hollow hole 6 of the reducer 5 etc., so as to prevent the wire bodies 11 from contacting the inner surface of the hollow hole 6. Alternatively, the pipe 7 may be omitted if the hollow hole 6 has a sufficiently large inner diameter.

1. A wire-body-managing device for routing a plurality of wire bodies between a first member and a second member that are supported so as to be relatively rotatable about a prescribed axis, the wire-body-managing device comprising:
an attachment unit for attaching to the second member; and
a wire-body-securing part that secures the wire bodies that passes, along the axis, through a hollow hole provided in a space including the axis of the first member and the second member, the wire bodies being bent on a side of the second member in directions intersecting the axis,
wherein the plurality of the wire bodies are divided into a plurality of groups and are bent in different angular directions about the axis, and the wire-body-securing part secures the groups of the wire bodies to different circumferential positions about the axis.

2. The wire-body-managing device according to claim 1, wherein the groups of the wire bodies that pass through the hollow hole are bent into a U shape or an L shape and are secured to the wire-body-securing part.

3. The wire-body-managing device according to claim 1, further comprising:
a guide member disposed at a position remote from an end portion of the hollow hole in a direction of the axis,
wherein the guide member contacts outer surfaces of the groups of the wire bodies that pass through the hollow hole so as to regulate curvature of bends of the wire bodies.

4. The wire-body-managing device according to claim 1, further comprising a wall that isolates a space where the wire bodies secured to the wire-body-securing part are disposed from a movable part that is disposed on the side of the second member and is movable with respect to the second member.

5. The wire-body-managing device according to claim 4,
wherein the movable part is disposed at such a position that the movable part surrounds an outer radial side of the hollow hole, and
the wall is disposed at such a position that the wall surrounds an outer radial side of the movable part.

6. The wire-body-managing device according to claim 4, wherein the wire-body-securing part is disposed on the wall.

7. The wire-body-managing device according to claim 6,
wherein the wall has a plate shape and includes a plurality of walls at such positions that the walls surround the outer radial side of the movable part, and
the wire-body-securing part is disposed at a position spaced from the axis to each of the walls with respect to a perpendicular line.

8. A wire-body-managing method for routing a plurality of wire bodies between a first member and a second member that are supported so as to be relatively rotatable about a prescribed axis, the method comprising:
allowing the plurality of wire bodies to pass, along the axis, through a hollow hole provided in a space including the axis of the first member and the second member;
dividing the plurality of wire bodies that pass to a side of the second member into a plurality of groups; and
bending the groups of the wire bodies in different angular directions about the axis, the directions intersecting the axis, and securing the groups of the wire bodies to the second member at different circumferential positions about the axis.

9. The wire-body-managing method according to claim 8, wherein the groups of the wire bodies that pass through the hollow hole to the side of the second member are bent into a U shape or an L shape and secured to the second member.

10. The wire-body-managing method according to claim 8, wherein curvature of bends of the wire bodies is regulated by causing a guide member to come into contact with outer surfaces of the wire bodies that pass through the hollow hole to the side of the second member, the guide member being at a position remote from an end portion of the hollow hole in a direction of the axis.

11. A robot comprising:
a first member and a second member that are supported so as to be relatively rotatable about a prescribed axis;
the wire-body-managing device according to claim 1 with the attachment unit secured to the second member; and
a plurality of the wire bodies that pass through the hollow hole along the axis, that are bent in directions intersecting the axis on the side of the second member, and that are secured to the wire-body-securing part.
